(19) United States
(12) Patent Application Publication
(10) Pub. No.: US 2012/0113203 A1
(43) Pub. Date: May 10, 2012

(54) TRANSFER TYPE INKJET RECORDING METHOD AND TRANSFER TYPE INKJET RECORDING DEVICE

(75) Inventors: Midori Kushida, Tokyo (JP); Hikaru Ueda, Kawasaki-shi (JP)

(73) Assignee: CANON KABUSHIKI KAISHA, Tokyo (JP)

(21) Appl. No.: 13/291,809

(22) Filed: Nov. 8, 2011

(30) Foreign Application Priority Data
Nov. 10, 2010 (JP) 2010-251676

(51) Int. Cl. B41J 2/01

(52) U.S. Cl. 347/103

(57) ABSTRACT

The transfer type inkjet recording method has the intermediate image formation process and the transfer process defined in the specification. The transfer type inkjet recording method includes, in the intermediate image formation process, selecting an intermediate transfer body having a center line surface roughness closest to the center line surface roughness of a recording medium from a plurality of intermediate transfer bodies different from each other in the center line surface roughness, and then an intermediate image is formed on the surface of the selected intermediate transfer body. Moreover, a transfer type inkjet recording which is used for the method is provided.

### BACKGROUND OF THE INVENTION

1. Field of the Invention

The present invention relates to a transfer type inkjet recording method and a transfer type inkjet recording device which can be used for the method.

2. Description of the Related Art

The transfer type inkjet recording method typically has the following processes. More specifically, the transfer type inkjet recording method has an intermediate image formation process for forming an intermediate image by supplying ink to the surface of an intermediate transfer body using an inkjet device and a transfer process for pressure-bonding a recording medium to the intermediate transfer body on which the intermediate image is formed to transfer the intermediate image to the recording medium. An image formation device for use in the transfer type inkjet recording method has the intermediate transfer body supporting the intermediate image.

Here, mentioned as the intermediate transfer body to be used in the transfer type inkjet recording method which has been proposed heretofore is one having a concavo-convex layer on the surface.

Japanese Patent Laid-Open No. 2002-370442 discloses, as an example, an intermediate transfer body having a concavo-convex layer in which ethylene tetrafluoride is used as the material and whose surface roughness Ra measured by a surface roughness meter (RST/PLUS manufactured by WYCO) is 0.2 μm to 2.5 μm. In this example, it is supposed that good transfer properties are obtained by providing an intermediate transfer body having a surface roughness in an appropriate range for transfer type inkjet recording methods.

Japanese Patent Laid-Open No. 2009-078391 discloses, as an example, an image formation device which has a concavo-convex formation unit and which forms a concavo-convex layer, which is crushed to be flattened in transferring, on the surface of an intermediate transfer body. In this example, it is supposed that since the concavo-convex layer on the surface of the intermediate transfer body is crushed to be flattened in transferring, good transfer properties are obtained to various kinds of recording media different in the surface roughness.

The present inventors have examined the above-described techniques in detail. As a result, the present inventors have found for the first time that such an image formation device for use in the transfer type inkjet recording method has the following problems. More specifically, there is a problem in that, a recording medium after transferring has a considerable difference in the apparent texture between a portion where an intermediate image by ink is transferred (referred to as an image drawn portion) and a portion where the intermediate image is not transferred and the original recording medium is exposed (referred to as a non-image-drawn portion).

The problem is more specifically described. Mentioned as the recording medium for use in the recording method are various kinds of recording media, such as paper, resin film, and fabric. The texture of the surface of the recording media is different from each other. Among the most frequently used paper, various kinds of paper, such as a coated paper, a mat paper, a glossy paper, and a high quality paper, are mentioned and the texture of the surface of the recording media is different from each other.

As one particularly very important texture when determining the value as printed substances, glossy feeling is mentioned. The glossy feeling of printed substances is treated as an important factor which affects the commercial value thereof and is selected based on whether the recording medium is suitable for obtaining a target glossy feeling in many cases.

In the image drawn portion obtained by the transfer type inkjet recording method, the shape of the intermediate transfer body in transferring is literally transferred, and therefore, a glossy feeling unrelated to the glossy feeling of the original recording medium is exhibited. In other words, a high glossy feeling portion and a low glossy feeling portion are mixed on the surface of one printed substance in some cases. The present inventors have found such a problem for the first time.

In the invention of Japanese Patent Laid-Open No. 2002-370442, the problem is not referred to at all. Also in the invention of Japanese Patent Laid-Open No. 2009-078391, techniques for solving the problem are not disclosed.

### SUMMARY OF THE INVENTION

Accordingly, the present invention provides a transfer type inkjet recording method and a transfer type inkjet recording device which can produce a printed substance with few differences in the glossy feeling between an image drawn portion and a non-image-drawn portion and a high commercial value even when various kinds of recording media are used.

The invention is a transfer type inkjet recording method, having an intermediate image formation process for forming an intermediate image by supplying ink to the surface of an intermediate transfer body using an inkjet device and a transfer process for pressure-bonding a recording medium to the intermediate transfer body on which the intermediate image is formed to transfer the intermediate image to the recording medium, in which, in the intermediate image formation process, the intermediate transfer body is selected so as to have a center line surface roughness closest to the center line surface roughness of the recording medium in terms of value from a plurality of intermediate transfer bodies different from each other in the center line surface roughness.

The invention is also a transfer type inkjet recording device, having an intermediate image formation mechanism for forming an intermediate image by supplying ink to the surface of a selected intermediate transfer body using an inkjet device and a transfer mechanism for pressure-bonding a recording medium to the selected intermediate transfer body on which the intermediate image is formed to transfer the intermediate image to the recording medium, in which the transfer type inkjet recording device is provided with a plurality of intermediate transfer bodies different from each other in the center line surface roughness, a mechanism for measuring the center line surface roughness of the recording medium, and a mechanism for selecting an intermediate transfer body having a center line surface roughness closest to the measured center line surface roughness of the recording medium in terms of value from the plurality of intermediate transfer bodies and supplying the selected intermediate transfer body to the intermediate image formation mechanism.

The invention can provide a transfer type inkjet recording method and a transfer type inkjet recording device which can produce a printed substance with few differences in the glossy feeling between an image drawn portion and a non-image-drawn portion and a high commercial value even when various kinds of recording media are used.

Further features of the present invention will become apparent from the following description of exemplary embodiments with reference to the attached drawings.

### BRIEF DESCRIPTION OF THE DRAWINGS

FIGS. 1A and 1B schematically illustrate the cross-sectional structure of an intermediate transfer body formed on a support member, in which FIG. 1A is a view schematically illustrating the cross-sectional structure of an intermediate transfer body containing two members (a concavo-convex layer and a surface layer member) and FIG. 1B is a view schematically illustrating the cross-sectional structure of an intermediate transfer body containing one member.

FIGS. 2A and 2B are views all illustrating the structure of a plurality of intermediate transfer bodies different in the center line surface roughness which are disposed on a common support member and have a common surface layer member.

FIG. 3 is a view schematically illustrating the structure in which one kind of an intermediate transfer body is formed on a drum-like support member.

FIG. 4 is a schematic view illustrating an example of a transfer type inkjet recording device according to the invention.

### DESCRIPTION OF THE EMBODIMENTS

The present inventors have conducted extensive researches on the problems of the former techniques described above. As a result, the present inventors have found that the configuration of the invention described above exhibits excellent performance to the problems as a transfer type inkjet recording method and a transfer type inkjet recording device, and has accomplished the invention.

The reason for exhibiting excellent performance described above is not clarified but the present inventors guess the reason as follows.

According to the transfer type inkjet recording method, the shape (e.g., irregularities) corresponding to the shape (e.g., concavo-convex layer) of the surface of the intermediate transfer body is formed on the surface of the final image of the intermediate image formed on the surface of the intermediate transfer body as described above.

The surface of the final image of the intermediate image is a surface at the side in contact with the intermediate transfer body of facing two surfaces of an ink layer constituting the intermediate image and is also a surface facing the surface at the side in contact with the recording medium in transferring. As a result, an image having the shape corresponding to the surface shape of the intermediate transfer body is formed on the surface of the recording medium. More specifically, the glossy feeling of the image drawn portion of a printed substance can be controlled by the shape of the surface of the intermediate transfer body.

In particular, the use of an intermediate transfer body having the center line surface roughness close to the center line surface roughness of the recording medium in terms of value allows a reduction in differences in the glossy feeling between the image drawn portion and the non-image-drawn portion, so that a printed substance having a high commercial value can be obtained.

However, according to a former method, images have been formed using one kind of an intermediate transfer body, and therefore when differences between the center line surface roughness of the intermediate transfer body and the center line surface roughness of the recording medium to be used have been very large, differences in the glossy feeling between the image drawn portion and the non-image-drawn portion have become remarkable in some cases.

In contrast, in the invention, a plurality of intermediate transfer bodies different from each other in the center line surface roughness are used, and therefore when printing is performed on various kinds of recording media, an intermediate transfer body suitable for the glossy feeling of each non-image-drawn portion can be selected. Thus, differences in the glossy feeling between an image drawn portion and a non-image-drawn portion can be reduced as compared with former methods, so that a printing substance with a high commercial value can be obtained, which is very suitable.

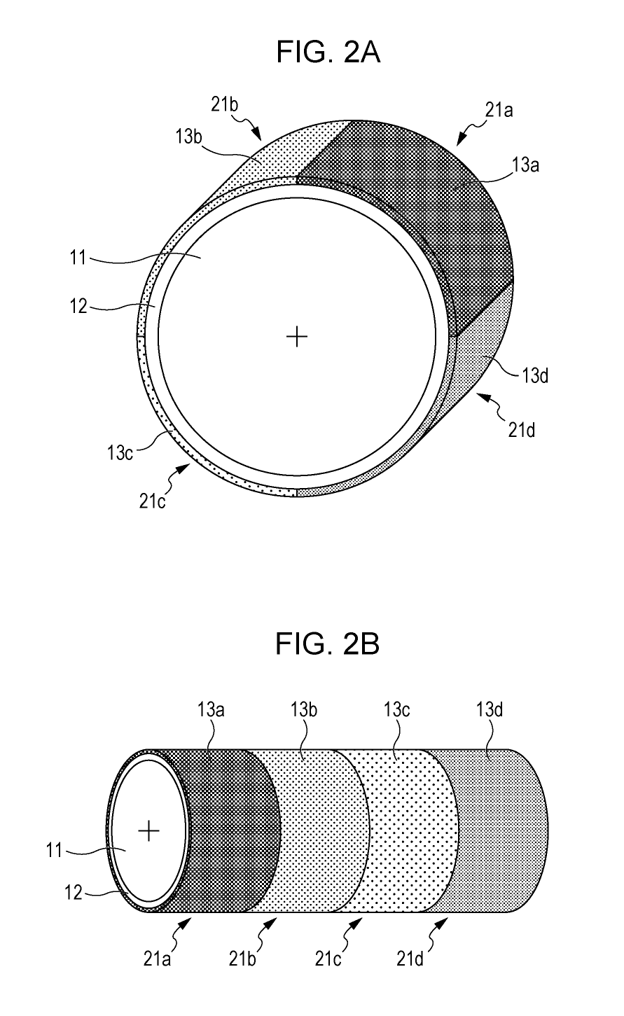

Differences in the center line surface roughness (Ra) of the plurality of intermediate transfer bodies are suitably all 0.5 μm or more. The fact that the differences in the center line surface roughness the plurality of intermediate transfer bodies are all 0.5 μm or more can be stated in another way as follows. When an operation of selecting one intermediate transfer body from the plurality of intermediate transfer bodies, and comparing the center line surface roughness of the intermediate transfer body and the center line surface roughness of the other plurality of intermediate transfer bodies one by one is performed for every intermediate transfer body, the difference of the two intermediate transfer bodies is always 0.5 μm or more. For example, in four intermediate transfer bodies 21a to 21d (in which a surface layer member 12 is common) as illustrated in FIGS. 2A-B, the difference in the center line surface roughness of two intermediate transfer bodies is 0.5 μm or more in any combination of all the combinations (six combinations) in which two intermediate transfer bodies are selected from the four intermediate transfer bodies. Thus, even when a very large variety of intermediate transfer bodies are not used, a printed substance with a sufficiently high commercial value can be easily obtained on almost all recording media. In order to sufficiently demonstrate the effects of the invention, it is suitable to use intermediate transfer bodies in which the differences are all 3.0 μm or lower. When the differences of the center line surface roughness are 3.0 μm or lower, the center line surface roughness of an intermediate transfer body with a higher Ra value can be easily prevented from becoming very high. As a result, the differences in the glossy feeling between the image drawn portions and the non-image-drawn portions on printed substances can be easily prevented from becoming large, so that a reduction in the worth of the printed substances can be easily prevented.

The transfer type inkjet recording device of the invention has a mechanism for measuring the center line surface roughness of a recording medium and a mechanism for selecting an intermediate transfer body having a center line surface roughness closest to the measurement results in terms of value from the plurality of intermediate transfer bodies and supplying the same to the intermediate image formation mechanism. Thus, also when printing is continuously performed on various kinds of recording media, the surface of the most suitable intermediate transfer body is automatically applied, and therefore the workload of users is reduced, which is very suitable.

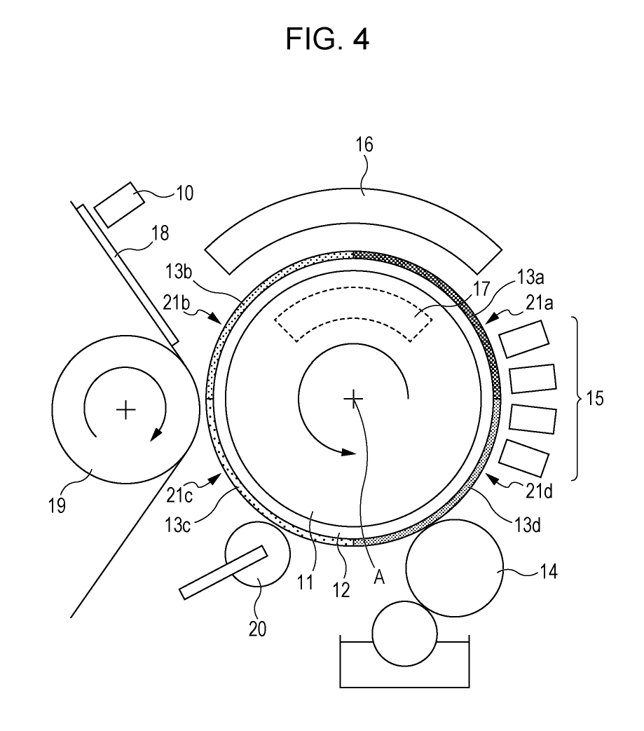

Hereinafter, the outline of one embodiment of the transfer type inkjet recording method and the transfer type inkjet recording device of the invention is described in detail with reference to FIG. 4. FIG. 4 is a schematic view illustrating an example of a transfer type inkjet recording device suitably used for the transfer type inkjet recording method of the invention.

### Inkjet Recording Method and Inkjet Recording Device

The transfer type inkjet recording method of the invention has an intermediate image formation process and a transfer process and uses the plurality of intermediate transfer bodies. The intermediate image formation process is a process for forming the intermediate image by supplying ink to the surface of the intermediate transfer bodies using an inkjet device.

In the intermediate image formation process, an intermediate transfer body having the center line surface roughness closest to the center line surface roughness of a recording medium in terms of value is selected from the plurality of intermediate transfer bodies, and the intermediate image is formed on the surface of the intermediate transfer body. The transfer process is a process for pressure-bonding a recording medium to the intermediate transfer body on which the intermediate image is formed to transfer the intermediate image to the recording medium.

The transfer type inkjet recording method of the invention can have a condensate supply process, a moisture removal process, and a cleaning process described later in addition to these processes.

The transfer type inkjet recording device of the invention can be used for the above-described transfer type inkjet recording method and has the following components. More specifically, the transfer type inkjet recording device of the invention has a plurality of intermediate transfer bodies different from each other in the center line surface roughness, an intermediate image formation mechanism, a transfer mechanism, a mechanism for measuring the center line surface roughness of a recording medium, and a mechanism for selecting an intermediate transfer body and supplying the same to the intermediate image formation mechanism (intermediate transfer body selecting and supplying mechanism) described later. Furthermore, the transfer type inkjet recording device of the invention can have a condensate supply mechanism, a moisture removal mechanism, and a cleaning mechanism.

The recording device of FIG. 4 has the following components: intermediate transfer bodies 21a to 21d disposed on a support member 11; an inkjet device 15 as the intermediate image formation mechanism; a pressurization roller 19 as the transfer mechanism to a recording medium 18; an Ra measurement mechanism 10 as the mechanism which measures the center line surface roughness of a recording medium; an intermediate transfer body selecting and supplying mechanism (non-illustrated); a roller application device 14 as the condensate supply mechanism; a blowing device 16 and a heating heater 17 as the moisture removal mechanism; and a cleaning unit 20 as the cleaning mechanism. These components are described below.

### Support Member

The support member 11 is required to have a certain degree of structural strength from the viewpoint of the conveyance accuracy and durability. As materials of the support member 11, metal, ceramics, resin, and the like are suitable. In particular, the following materials are suitably used for the support member 11 in terms of rigidity with which the support member 11 can bear the pressurization in transferring or dimension accuracy and properties required for reducing the inertia during movement to improve the responsiveness to control. For example, aluminum, iron, stainless steel, acetal resin, epoxy resin, polyimide, polyethylene, polyethylene terephthalate, nylon, polyurethane, silica ceramics, alumina ceramics, and the like are mentioned. The materials are suitably used in combination.

As the support member 11, a roller shape support member or a belt shape support member can be suitably used, for example, in accordance with the type of a recording device to be applied or a transfer aspect to a recording medium. When a drum-like support member or a belt-like support member having an endless web configuration is used, the same intermediate transfer body can be repeatedly and continuously used, which is a very suitable configuration in terms of productivity.

### Intermediate Transfer Body

In the transfer type inkjet recording method of the invention, a plurality of intermediate transfer bodies different in the center line surface roughness are used and the transfer type inkjet recording device of the invention has the plurality of intermediate transfer bodies as described above. In accordance with the center line surface roughness of the recording medium to be used, one suitable intermediate transfer body is selected and used for the formation of an intermediate image.

The intermediate transfer body holds ink and serves as a base material for forming an image. The intermediate transfer body is typically formed on the support member 11 for transmitting power required for handling the intermediate transfer body.

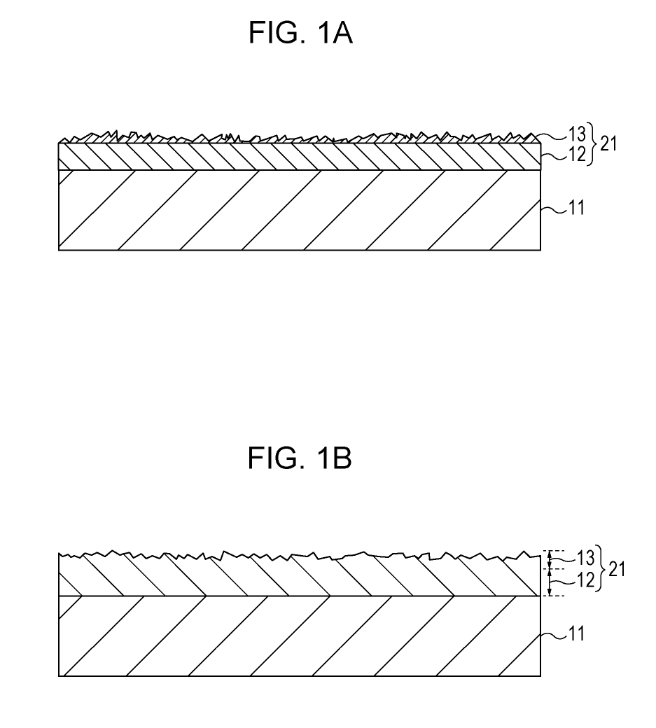

FIGS. 1A and 1B illustrates schematically cross sectional views of the intermediate transfer body 21 which can be used in the invention. The intermediate transfer body 21 disposed on the support member 11 may be configured by two members (a surface layer member 12 and a concavo-convex layer 13) as illustrated in FIG. 1A or may be configured by one member as illustrated in FIG. 1B. The surface layer member 12 functions not as the surface layer of the intermediate transfer body but as an intermediate layer. In the invention, irregularities may be formed in the surface layer member 12 and the concavo-convex layer 13 may be configured in such a manner as to follow the irregularities in the surface layer member 12. In this case, the center line surface roughness Ra of the surface layer member 12 becomes inevitably larger than Ra of the concavo-convex layer 13.

The surface of the intermediate transfer body 21 (surface of the concavo-convex layer 13) can also be a plane (The center line surface roughness Ra described later can be 0.).

The support member 11 and the intermediate transfer body 21 may contain a uniform (same) member or may contain a plurality of members which are independent from each other as illustrated in FIG. 1.

The concavo-convex layer 13 when at least the surface layer member 12 and the concavo-convex layer 13 contain a uniform member refers to a portion ranging from the upper end of the concavo-convex portion (protruding portion) to the lower end (concave portion) thereof. In FIG. 1B, the surface layer member 12 and the concavo-convex layer 13 are formed with a uniform member. The concavo-convex layer 13 is a portion ranging from the upper end of a concavo-convex portion to the lower end thereof and the other portion serves as the surface layer member 12.

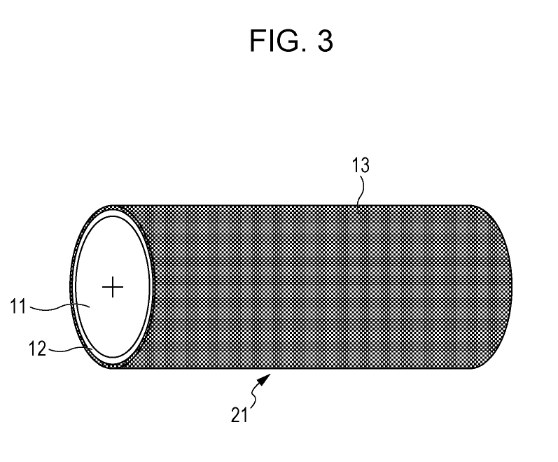

As the arrangement of the intermediate transfer body, one intermediate transfer body may be disposed on one support member as illustrated in FIG. 3 or a plurality of intermediate transfer bodies may be disposed on a common support member. Moreover, as illustrated in FIGS. 2A and 2B, it may be configured that the plurality of intermediate transfer bodies (21a to 21d) have the surface layer member 12 common thereto and are constituted by a plurality of concavo-convex layers (13a to 13d) different in the center line surface roughness. The center line surface roughness of the concavo-convex layers 13 can be considered as the center line surface roughness of the intermediate transfer bodies 21.

Mentioned as the entire shape of the intermediate transfer bodies are a sheet shape, a roller shape, a drum shape, a belt shape, an endless web shape, and the like. The size of the intermediate transfer bodies can be freely selected in accordance with the target printing image size.

As illustrated in FIG. 4, the surface layer member 12 and the four sheet-like intermediate transfer bodies 21a to 21d constituted by the four concavo-convex layers 13a to 13d can be fixed to the external surface of a rotatable drum-like support member 11 for use. It can be configured that the support member 11 is rotated in the direction indicated by the arrow around the axis A to be driven, and each device disposed on the periphery thereof operates synchronizing with the rotation. The structure of the intermediate transfer bodies is the same as that illustrated in FIG. 2A.

### Surface Member

The surface layer member 12 of the intermediate transfer bodies is desirably to have a certain degree of elasticity because an intermediate image is pressure-bonded to a recording media, such as paper, to transfer the intermediate image. For example, when paper is used as the recording medium, the surface layer member 12 of the intermediate transfer bodies suitably has a Durometer type A (according to JIS K 6253) hardness of 10° or more and 100° or lower and particularly more suitably 20° or more and 60° or lower.

As materials of the surface layer member 12, various kinds of materials, such as resin and ceramics, can be used as appropriate. In terms of the above-described properties and processing properties, various kinds of elastomeric materials and rubber materials are suitably used. Mentioned as such materials are, for example, silicone rubber, fluorosilicone rubber, phenyl silicone rubber, fluororubber, chloroprene rubber, nitrile rubber, ethylene-propylene rubber, natural rubber, styrene rubber, isoprene rubber, butadiene rubber, a copolymer of ethylene/propylene/butadiene, nitrile butadiene rubber, and the like. In particular, silicone rubber, fluorosilicone rubber, phenyl silicone rubber, fluororubber, and chloroprene rubber can be extremely suitably used in terms of dimensional stability, durability, and heat resistance.

As the surface layer member 12, one formed by laminating a plurality of materials can also be suitably used. For example, a laminated material in which a polyurethane belt is thinly coated with silicone rubber can be extremely suitably used as the surface layer member 12.

The surface layer member 12 can be subjected to an appropriate surface treatment for use. Mentioned as an example of the surface treatment are frame treatment, corona treatment, plasma treatment, polishing treatment, roughing treatment, activity energy ray irradiation treatment (UV•IR•RF and the like), ozonization, and surfactant treatment. Two or more kinds of the treatment may be performed in combination.

Between the surface layer member 12 and the support member 11, various kinds of adhesives or double-stick tapes for fixing and holding the same may be provided.

### Concavo-Convex Layer

The intermediate transfer bodies for use in the invention can be configured to have the concavo-convex layer 13 on the surface layer member 12. As described above, the concavo-convex layer may be the same member as or may be a member different from that of the surface layer member 12 and the support member 11.

The plurality of intermediate transfer bodies (a plurality of concavo-convex layers when the surface layer member is common) each may be formed using different materials or may be formed using the same material. The plurality of intermediate transfer bodies are different from each other in the center line surface roughness. More specifically, the concavo-convex layers on the plurality of intermediate transfer bodies' surfaces are different from each other in the center line surface roughness. In the manufacturing method and manufacturing device of the invention, the number of the intermediate transfer bodies is suitably 2 or more and suitably 7 or lower from the viewpoint of a reduction in productivity due to replacement.

The hardness (elastic modulus) of these concavo-convex layers 13 is suitably higher than that of an intermediate image layer to be formed on the surface of the intermediate transfer bodies in the intermediate image formation process. Specifically, the elastic modulus at a transfer temperature is suitably 300 MPa or more.

When the concavo-convex layers 13 are harder than the intermediate image layer, a deformation of the surface shape of the intermediate transfer bodies can be easily prevented when forming the surface shape of the intermediate transfer bodies on the final image surface of the intermediate image layer just like emboss processing in transferring, so that the surface shape of the intermediate transfer bodies is easily formed on the final image surface. Specifically, when the elastic modulus is 300 MPa or more, the surface shape of the intermediate transfer bodies can be easily formed on the final image surface under various conditions, which is suitable.

Materials forming the concavo-convex layers 13 are not particularly limited insofar as a plurality of intermediate transfer bodies different from each other in the center line surface roughness can be formed, and silicone resin, fluororesin, metal, ceramics, and the like are suitably used from the viewpoint of the processability, the transfer properties of an ink image, and the like.

With respect to the surface shape (concavo-convex shape of all of the concavo-convex layers 13) of the plurality of intermediate transfer bodies, the center line surface roughness (Ra) is suitably 0.0001 μm or more and 3.0 μm or lower. A mirror-finished surface (Ra is 0) may be acceptable. When the center line surface roughness (Ra) is 0.0001 μm or more, ink can be easily prevented from easily moving on the surface of the intermediate transfer bodies, so that the occurrence of image distortion can be easily prevented. In contrast, when the center line surface roughness (Ra) is 3.0 μm or lower, a reduction in the contact surface area of the intermediate image and paper in transferring can be easily prevented, so that a reduction in the transfer properties can be easily prevented.

The center line surface roughness (Ra) for use in the invention is defined by the method specified by JIS B0601-2001 and can be measured using a color 3D laser beam microscope VK-9700 (trade name, manufactured by KEYENCE CORP.). Hereinafter, the center line surface roughness is referred to as Ra.

A method for producing the surface shape of the intermediate transfer body for use in the invention is not particularly specified, and any known method can be suitably used. Specifically, sandblast processing, embossing (stamping), dies cutting, active energy ray processing, such as corona discharging, photolitho processing using optical curable resin, and the like can be suitably used.

The transfer type inkjet recording device of the invention has a plurality of intermediate transfer bodies, and the central surface roughness (Ra) of the plurality of intermediate transfer bodies are different from each other. When the differences in Ra of the plurality of intermediate transfer bodies are all 0.5 μm or more, a gloss difference between an image drawn portion and a non-image-drawn portion can be easily disregarded with respect to substantially almost all recording media, which is very suitable.

The support member 11 and the surface layer member 12 provided under the concavo-convex layers 13 may be common to the plurality of intermediate transfer bodies or different. The plurality of intermediate transfer bodies in which the support member 11 and the surface layer member 12 are common can be obtained by disposing a plurality of concavo-convex layers different from each other in the Ra on a cylindrical (drum shape) support member 11 whose side surface is uniformly covered with the surface layer member 12, for example. FIGS. 2A-B schematically illustrates the shape. In FIG. 2B, the four intermediate transfer bodies 21a to 21d have the concavo-convex layers 13a to 13d, respectively, on the surface. The Ra of these concavo-convex layers, i.e., Ra of the intermediate transfer bodies, is different from each other. In the invention, a plurality of intermediate transfer bodies different from each other in the center line surface roughness may just be present. For example, intermediate transfer bodies having the same center line surface roughness may be present in addition to the plurality of intermediate transfer bodies.

### Intermediate Image Formation Process and Mechanism

The recording device of the invention is provided with the following Ra measurement mechanism 10 and intermediate transfer body selecting and supplying mechanism (not illustrated). In the recording method of the invention, by the use of the mechanisms, an intermediate transfer body having an Ra closest to the Ra value of a recording medium in terms of value can be selected from the plurality of intermediate transfer bodies and can be used for the intermediate image formation process.

In the recording device of the invention, an aspect is acceptable in which the plurality of intermediate transfer bodies 21a to 21d different in Ra are disposed beforehand on the common support member 11 as illustrated in FIGS. 2A-B and 4. In the case of the aspect illustrated in FIG. 3, an aspect is acceptable in which only the support member 11 is disposed beforehand, and only one intermediate transfer body selected from the plurality of intermediate transfer bodies is fitted onto the support member by the intermediate transfer body selecting and supplying mechanism. In this case, the entire range on the support member can be used as the intermediate transfer body. Therefore, the aspect is suitable from the viewpoint of productivity when printing a large number of copies using one kind of paper. Ra measurement mechanism and intermediate transfer body selecting and supplying mechanism

As described above, the transfer type inkjet recording device of the invention has the mechanism for measuring the Ra of the recording medium to be used and the mechanism for selecting an intermediate transfer body having an Ra closest to the Ra of the measurement results in terms of value from the plurality of intermediate transfer bodies and supplying the same to the intermediate image formation mechanism. By the mechanism for measuring the Ra of the recording medium, the Ra is measured when the recording medium is supplied to the recording device. By selecting an intermediate transfer body having an Ra value closest to the value and using the same for the formation of an intermediate image, users can always continuously obtain printed substances with few differences in the glossy feeling between the image drawn portion and the non-image-drawn portion without being particularly aware of the differences. When there are two or more intermediate transfer bodies having an Ra value closest thereto, any one of the intermediate transfer bodies can be selected. The intermediate image formation mechanism refers to a device which gives ink to the surface of the intermediate transfer body to form an image and, for example, an inkjet device 15 can be mentioned.

As the Ra measurement mechanism, any known Ra measurement mechanism can be suitably used. For example, JIS B0601 describes an example of the Ra measurement mechanism in detail.

Usable as the intermediate transfer body selecting and supplying mechanism is, for example, a system in which a control device which compares the Ra data of paper sent from the Ra measurement mechanism with the Ra data of the intermediate transfer bodies input beforehand, selects an intermediate transfer body having the closest Ra, and outputs a signal and a device which takes out the intermediate transfer body from a storing place and fits the same onto a support member are interlocked.

### Condensate Supply Process and Mechanism

The recording method and the recording device of the invention may have condensate supply process and mechanism which, before supplying ink to the surface of the selected intermediate transfer body, gives a condensate which contacts color material components in the ink to form a viscosity-increased ink image to the surface of the intermediate transfer body beforehand. In FIG. 4, as a device (condensate supply mechanism) which gives the condensate, the roller application device 14 is disposed. Thus, it is configured that the condensate is continuously given to the surface of the intermediate transfer body.

The condensate for use in the invention contains an ink viscosity increasing component. Here, the ink viscosity increasing component refers to a component which contacts color materials, resin, and the like constituting ink to cause chemical reaction of the color materials, resin, and the like or physical adsorption to thereby increase the viscosity of the entire ink. The ink viscosity increasing component also includes, as a concept, a component which locally increases the viscosity by coagulating a part of ink, such as color materials, due to contact therewith.

This component has an effect of reducing the fluidity of ink on the intermediate transfer body (also including the case of increasing the viscosity of a part of ink to cause a reduction in the fluidity of the ink as a result) to thereby suppresses bleeding and beading in image formation. More specifically, in the image formation using an inkjet device, the ink supply amount per unit area becomes large in some cases. In such a case, bleeding or beading which is spreading or mixing of ink is likely to occur. However, due to the fact that the condensate is supplied onto the intermediate transfer body, the fluidity can be easily reduced when an image is formed with ink, so that bleeding or beading is more difficult to occur. As a result, good images can be easily formed and held.

The ink viscosity increasing component to be used is desirably selected as appropriate depending on the type of ink for use in the image formation. For example, it is effective to use a polymer coagulant for a dye ink and it is effective to use liquid containing polyvalent metal ions or a pH adjuster, such as an acid buffer solution, for a pigment ink in which fine particles are dispersed. As another example of the ink viscosity increasing component, compounds having a plurality of ionic groups, such as a cation polymer, may be used. The combination use of two or more kinds of these compounds is also effective.

Specifically mentioned as the polymer coagulant usable as the ink viscosity increasing component are, for example, a positive ionic polymer coagulant, a negative ionic polymer coagulant, a nonionic polymer coagulant, an ampholytic polymer coagulant, and the like.

When liquid containing polyvalent metal ions is used for the condensate, the metal species and the metal concentration can be changed as appropriate according to the conditions. Specifically mentioned as metal ions usable as the ink viscosity increasing component are the following substances. For example, divalent metal ions, such as Ca²⁺, Cu²⁺, Ni²⁺, Mg²⁺, Sr²⁺, Ba²⁺, and Zn²⁺, or trivalent metal ions, such as Fe³⁺, Cr³⁺, Y³⁺, and Al³⁺, are mentioned. When liquid containing these metal ions is applied to the surface of the selected intermediate transfer body, the liquid is desirably applied as an aqueous metal salt solution. As negative ions of metal salts, Cl⁻, NO₃⁻, CO₃²⁻, SO₄²⁻, I⁻, Br⁻, ClO₃⁻, HCOO⁻, RCOO⁻ (R is an alkyl group), and the like are mentioned but the negative ions of metal salts are not limited thereto.

The metal salt concentration of the aqueous metal salt solution is suitably 0.01% by mass or more and more suitably 0.1% by mass or more. Moreover, 20% by mass or lower is suitable.

Specifically, as a pH adjuster usable as the ink viscosity increasing component, an acidic solution whose pH is lower than 7 is suitably used. Mentioned as an example are inorganic acids, such as hydrochloric acid, phosphoric acid, sulfuric acid, nitric acid, and boric acid and organic acids, such as oxalic acid, polyacrylic acid, acetic acid, glycolic acid, malonic acid, malic acid, maleic acid, ascorbic acid, succinic acid, glutaric acid, fumaric acid, citric acid, tartaric acid, lactic acid, pyrrolidone carboxylic acid, pyronecarboxylic acid, pyrrole carboxylic acid, furancarboxylic acid, pyridine carboxylic acid, coumarinic acid, thiophene carboxylic acid, and nicotinic acid. Moreover, derivatives of these compounds or a solution of these salts can be similarly suitably used.

An acid buffer solution having a pH buffering ability (buffer) is extremely suitably used as the condensate because even when the apparent concentration of the condensate decreases due to ink, the pH hardly changes, so that the reactivity with the ink does not particularly decrease. In order to obtain the pH buffering ability, it is suitable to compound a buffer agent in the condensate. Specific examples of usable buffer agents are acetates, such as sodium acetate, potassium acetate, and lithium acetate and hydrogen salts of polyvalent carboxylic acids, such as hydrogen phosphorate, hydrogencarbonat, and sodium hydrogen phthalate, and potassium hydrogen phthalate. Mentioned as specific examples of the polyvalent carboxylic acids are, in addition to phthalic acid, malonic acid, maleic acid, succinic acid, fumaric acid, itaconic acid, phthalic acid, isophthalic acid, terephthalic acid, adipic acid, sebacic acid, dimer acid, pyromellitic acid, trimellitic acid, and the like. In addition to the above-mentioned substances, any known compound that develops a pH buffering action by addition can be suitably used.

In the condensate according to the invention, an appropriate amount of an aqueous medium or an organic solvent may be compounded. A solution in which the above-described ink viscosity increasing component is dissolved in an aqueous medium or an organic solvent can be used as the condensate. Mentioned as an example of the aqueous medium are water and a mixed solvent of water and a water-soluble organic solvent, for example. As a specific example of a solvent for dissolving the ink viscosity increasing component, the following substances can be mentioned. More specifically, alkane diols, such as 1,3-butanediol, 1,5-pentanediol, 1,2-hexanediol, and 1,6-hexanediol; glycol ethers, such as diethylene glycol monomethyl (or ethyl) ether and triethylene glycol monoethyl (or butyl) ether; alkyl alcohols in which the number of carbon atoms is 1 or more and 4, such as ethanol, isopropanol, n-butanol, isobutanol, secondary butanol, and tertiary butanol; carboxylic acid amides, such as N,N-dimethyl formamide and N,N-dimethyl acetamide; ketones or ketoalcohols, such as acetone, methylethyl ketone, and 2-methyl-2-hydroxypentane-4-one; cyclic ethers, such as tetrahydrofuran and dioxane; glycerin; alkylene glycols, such as ethylene glycol, diethylene glycol, triethylene glycol, tetraethylene glycol, 1,2- or 1,3-propylene glycol, 1,2- or 1,4-butylene glycol, and polyethylene glycol; polyhydric alcohols, such as thiodiglycol, 1,2,6-hexane triol, and an acetylene glycol derivative; sulfur containing compounds, such as 2-pyrrolidone, N-methyl-2-pyrrolidone, 1,3-dimethyl-2-imidazolidinone, and dimethylsulfoxide; and the like are suitably used. A mixture of two or more kinds of substances selected from the above-mentioned substances can also be used.

In order to obtain a condensate having a desired physical property value as required, a surfactant, an antifoaming agent, an antiseptic, an antifungal agent, and the like can be added as appropriate in addition to the above-mentioned components. Moreover, various kinds of resin can also be added to the condensate in order to increase the transfer properties or the solidity of a finally formed image. By the addition of resin, the adhesiveness to a recording target in transferring can be made more favorable and the mechanical strength of an ink coating film can be further increased. Depending on the kind of the resin, a further increase in water resistance of an image can also be expected. Materials for use in the resin are not limited insofar as the materials can be present with the ink viscosity increasing component. For example, organic polymers, such as polyvinyl alcohol and polyvinyl pyrrolidone, can be suitably used. Resin which reacts with components contained in the ink to be crosslinked therewith is also suitable. Mentioned as examples is oxazoline or carbodiimide which reacts with carboxylic acid which is frequently used for dispersion of color materials in the ink to be crosslinked therewith.

The resin may be dissolved in the condensate or may be added to the condensate in an emulsion state or a suspension state.

To the condensate, a surfactant can be added to adjust the surface tension as appropriate for use. As the surfactant, known surfactants, such as ionic surfactants, nonionic surfactants, cationic surfactants, and anionic surfactants, can be selected as required and as appropriate.

The above-described condensate is supplied onto the intermediate transfer body before ink is supplied by an inkjet device for use.

As a method for supplying the condensate, a method using various known supply mechanisms as appropriate as the condensate supply mechanism can be mentioned. Mentioned as the supply mechanism are die coating, blade coating, gravure roller, one obtained by combining an offset roller thereto, and the like, for example. It is also extremely suitable to use an inkjet device as a mechanism capable of supplying the condensate with high rate and high precision.

When the ink described later is supplied to the image formation surface of the intermediate transfer body to which the condensate has been supplied using an inkjet device, the condensate and the ink contact on the surface, so that a viscosity-increased ink image is formed as an intermediate image. Thus, bleeding or beading of the intermediate image can be further reduced, which is more suitable.

Subsequently, the above-described condensate is supplied to the surface of the selected intermediate transfer body as required, ink is supplied in the shape of an image using the inkjet device 15 which is the intermediate image formation mechanism.

Mentioned as the inkjet device to be applied to the invention are, for example, a type in which film boiling is caused in ink by an electrothermal converter to form air bubbles to thereby eject the ink, a type in which ink is ejected by an electrothermal converter, a type in which ink is ejected using static electricity, and the like. In the invention, various kinds of inkjet devices proposed in the inkjet liquid ejection techniques can all be used. In particular, from the viewpoint of high speed and high density printing, one utilizing an electrothermal converter is suitably used.

The entire shape of the inkjet device is not particularly limited. A line head inkjet head in which ink ejection ports are arranged perpendicular to the movement direction of the intermediate transfer body or a shuttle head in which recording is performed while scanning the head perpendicular to the movement direction of the intermediate transfer body can also be used.

### Ink

The ink for use in the invention can be selected as appropriate from ink widely used as inkjet ink for use. Specifically, various kinds of ink in which color materials, such as dyes, carbon black, and organic pigments, are dissolved or dispersed or dissolved and dispersed can be used. Among the above, carbon black ink or organic pigment ink is particularly suitable because images having good weather resistance or color development properties are obtained.

From the viewpoint of load to the environment or bad smell in use, an aqueous ink containing water is suitable as the ink. In particular, ink containing 45% by mass or more of moisture in the ink and containing water as the main components of a solvent is very suitable. The content of color materials in the ink is suitably 0.1% by mass or more and more suitably 0.2% by mass or more. The content of color materials in the ink is suitably 15.0% by mass or lower and more suitably 10.0% by mass or lower. As the color materials, dyes, carbon black, organic pigments, resin accompanied by the same, and the like are included. For example, substances mentioned in Japanese Patent Laid-Open No. 2009-256599 can be used.

Moreover, in order to increase the solidity of the finally formed image, water-soluble resin or water-soluble crosslinking agents can also be added to the ink. Materials used as the water-soluble resin or the water-soluble crosslinking agents are not limited insofar as the materials can be present with other components in the ink. As the water-soluble resin, polyvinyl alcohol, polyvinyl pyrrolidone, and the like are suitably used, for example. As the water-soluble crosslinking agents, oxazoline or carbodiimide is suitably used in terms of ink stability. Moreover, reactive oligomers, such as polyethylene glycol diacrylate or acryloylmorpholine, can also be suitably used.

In the transfer type inkjet recording method using the intermediate transfer body, ink when transferring to a recording medium substantially contains only a color material and a high boiling point organic solvent in some cases. Therefore, it is effective to also compound an appropriate amount of organic solvents in the ink in order to increase the transfer properties. As the organic solvents to be used, water-soluble materials having a high boiling point and a low vapor pressure are suitable. For example, alkane diols, such as 1,3-butanediol, 1,5-pentanediol, 1,2-hexanediol, and 1,6-hexanediol; glycol ethers, such as diethylene glycol monomethyl (or ethyl)ether and triethylene glycol monoethyl (or butyl)ether; alkyl alcohols in which the number of carbon atoms is 1 or more and 4 or lower, such as ethanol, isopropanol, n-butanol, isobutanol, secondary butanol, and tertiary butanol; carboxylic acid amides, such as N,N-dimethyl formamide and N,N-dimethyl acetamide; ketones or ketoalcohols, such as acetone, methylethyl ketone, and 2-methyl-2-hydroxypentane-4-one; cyclic ethers, such as tetrahydrofuran and dioxane; glycerin; alkylene glycols, such as an ethylene glycol, diethylene glycol, triethylene glycol, tetraethylene glycol, 1,2- or 1,3-propylene glycol, 1,2- or 1,4-butylene glycol, and polyethylene glycol; polyhydric alcohols, such as thiodiglycol, 1,2,6-hexane triol, and an acetylene glycol derivative; and heterocyclic rings, such as 2-pyrrolidone, N-methyl-2-pyrrolidone, and 1,3-dimethyl-2-imidazolidinone; and sulfur containing compounds, such as N-methylmorpholine, are suitably used. A mixture of two or more kinds of substances selected from the above-mentioned substances can also be used.

The ink according to the invention may contain various additives, such as a pH adjuster, a rust-preventive agent, an antiseptic, an antifungal agent, an antioxidant, a reduction prevention agent, a neutralizer of water-soluble resin, and a salt, as required in addition to the above-described components. A surfactant can be added as appropriate to the ink to thereby adjust the surface tension.

The compounding ratio of the components constituting the ink is not limited and can be adjusted as appropriate in a range which allows ejection based on the ejection power, the nozzle diameter, and the like of the selected inkjet head.

When the ink is supplied to the image formation surface of the intermediate transfer body to which the above-described condensate has been supplied as required using an inkjet device, the condensate and the ink contact on the surface, so that a viscosity-increased ink image is formed as an intermediate image.

It is a matter of course that, in the formation of the intermediate image, an image in which a desired image is reversed (mirror image) is formed on the intermediate transfer body.

### Moisture Removal Process and Mechanism

It is also suitable that the transfer type inkjet recording method and recording device of the invention are provided with moisture removal process and mechanism which reduce the content of liquid, such as ink, constituting the intermediate image from the above-described intermediate image. By providing the moisture removal process and mechanism, when the content of liquid constituting the intermediate image is extremely large, running off or overflowing of a surplus liquid is prevented in the following pressure-bonding transfer process, so that the occurrence of image distortion or poor transfer can be easily prevented. In FIG. 4, a blowing device 16 and a heating heater 17 for heating the intermediate image from the back surface are disposed as the moisture removal mechanism. In addition thereto, devices for use in moisture removal methods described below can be used as the moisture removal mechanism.

As the moisture removal methods, various kinds of methods which have been used heretofore can all be suitably applied. For example, any of a heating method, a low humidity air blowing method, a pressure reducing method, an absorber contacting method, and a method in which the above-described methods are combined can be suitably used. The moisture removal process can also be performed by natural drying.

### Transfer Process and Mechanism

An image printed substance is obtained by pressure-bonding a recording medium to the intermediate image to transfer the intermediate image from the intermediate transfer body to the recording medium. In this case, the intermediate image is formed on the surface of an intermediate transfer body having an Ra closest to the Ra of the recording medium in terms of value in the invention. Therefore, the shape corresponding to the surface of the intermediate transfer body is formed on the surface of the final image of the intermediate image layer described above. As a result, as compared with the former technique in which only one kind of an intermediate transfer body is used, the surface of the image drawn portion exhibits controlled glossy feeling, so that a difference in the glossy feeling from the non-image-drawn portion can be reduced. Therefore, a printed substance with little sense of unevenness and a high commercial value can be produced.

When transferring, the intermediate transfer bodies (the surface layer member 12 and the concavo-convex layers 13), the intermediate image, and the recording medium 18 are pressurized from both sides using the support member 11 and the pressurization roller 19 which is the transfer mechanism as illustrated in FIG. 4, the image can be efficiently transferred, which is suitable. Pressurizing in many stages also has an effect of suppressing poor transfer, and thus is suitable. As the transfer mechanism, a thermal transfer method including dissolving ink due to heat and pressurizing and the like can be mentioned in addition to the above-described methods.

In this description, the “recording medium” includes not only paper for use in general printing but a wide range of printing media, such as cloth, plastic, film, and the like and a recording media. As a method for conveying the recording medium, in addition to a conveyance method using a conveyor belt, an aspect is also suitable in which the recording medium 18 is wound around the pressurization roller 19 to be used as a conveyance drum as illustrated in FIG. 4.

### Cleaning Process and Mechanism

The image formation process is completed as described above. From the viewpoint of productivity, the intermediate transfer body is continuously repeatedly used in some cases. In such a case, it is suitable for the recording method of the invention to have a cleaning process for cleaning and regenerating the surface of the intermediate transfer body before performing the next image formation.

As a method for performing cleaning and regeneration, various kinds of methods which have been used heretofore can all be suitably applied. A method of applying a cleaning liquid to the surface of the intermediate transfer body in the form of shower, a method of making a wet mollton roller abut on the surface of the intermediate transfer body for sweeping, a method of bringing the intermediate transfer body to the surface of a cleaning liquid, a wiping method using a wiper blade, and a method of supplying various energies, and the like are all suitably used. It is a matter of course that a method in which a plurality of the methods are combined is also suitable. As described above, in FIG. 4, the cleaning unit 20 is disposed as the cleaning mechanism. As the cleaning unit 20, a configuration can b used such that a mollton roller which is always humidified by ion exchanged water, for example, is intermittently made to abut on the surface. In addition thereto, the devices for use in the cleaning methods described above can be used as the cleaning mechanism.

As described above, the present inventors have found for the first time that a transfer type inkjet recording method and a transfer type inkjet recording device can be provided which can produce printed substances with few differences in the glossy feeling between the image drawn portion and the non-image-drawn portion and a high commercial value even when various kinds of recording media are used.

Moreover, when the embodiments of the invention are employed, effects of an extension of life-span of intermediate transfer bodies or an increase in transfer properties are developed in some cases.

### EXAMPLES

Hereinafter, the invention is described in more specifically with reference to Examples of the transfer type inkjet recording method and the transfer type inkjet recording device according to the invention. It is a matter of course that the invention is not limited to the following Examples.

### Example 1

In Example 1, the transfer type inkjet recording device illustrated in FIG. 4 was used. The configuration and the like of the recording device are specifically described below.

### Support Member and Intermediate Transfer Body

Four intermediate transfer bodies 21a to 21d containing a common surface layer member 12 and concavo-convex layers 13a to 13d formed on the surface of the surface layer member 12 were fixed to the external surface of a rotatable support member 11 having the shape of a drum for use. In order to distinguish the concavo-convex layers and the intermediate transfer bodies from concavo-convex layers and intermediate transfer bodies used in other Examples, the four concavo-convex layers are denoted by the reference characters 13a-1 to 13d-1 and the four intermediate transfer bodies are denoted by the reference characters 21a-1 to 21d-1, respectively.

For the support member 11, a cylindrical drum containing an aluminum alloy was used. The surface layer member 12 was a layer containing silicone rubber and was fixed to the support member 11 with a double-sided pressure sensitive adhesive tape. The support member 11 is rotated and driven in the direction indicated by the arrow around the axis A, and each device disposed on the periphery thereof operates synchronizing with the rotation. The structure of the intermediate transfer body is the same as that schematically illustrated in FIG. 2A.

The above-described concavo-convex layers 13a-1 to 13d-1 were formed by entirely coating the surface layer member 12 with optical curable fluorinated epoxy resin, partially exposing the same, and then developing non-exposed portions with 4-methyl-2-pentanone. Separately, an optical cured product (on the surface of which a concavo-convex shape is not formed) of the above-described fluorinated epoxy resin was produced and the elastic modulus at 25° C. of the optical cured product was measured to be 2900 MPa. The elastic modulus was measured according to JISK7181 using a viscoelasticity spectrometer (manufactured by SII Nanotechnology, trade name; EXSTAR DMS6100). The concavo-convex layers 13a-1 to 13d-1 formed by the above-described method, i.e., the intermediate transfer bodies 21a-1 to 21d-1, are different from each other in the Ra. The Ra of these four intermediate transfer bodies is shown in Table 1. The central line surface roughness (Ra) was measured using a color 3D laser beam microscope VK-9700 (trade name, manufactured by KEYENCE).

TABLE 1
Ra measurement mechanism and intermediate transfer
body selecting and supplying mechanism

| Intermediate transfer body | 21a-1 | 21b-1 | 21c-1 | 21d-1 |
|---|---|---|---|---|
| Ra [μm] | 0.21 | 1.01 | 1.98 | 2.54 |

The device was further provided with the following mechanisms. First, an Ra measurement mechanism 10 (laser beam microscope) capable of measuring the center line surface roughness (Ra) of the recording medium 18 before supplying the same was disposed. Moreover, an intermediate transfer body selecting and supplying mechanism (not illustrated) containing a control device was disposed which selects an intermediate transfer body having an Ra closest to the measurement results from the plurality of intermediate transfer bodies 21a-1 to 21d-1, and outputs a signal. The device is configured to control the process starting position of the intermediate transfer body having a drum shape described below, so that an intermediate image is formed on the surface of the intermediate transfer body having an Ra closest to the measurement results.

### Condensate Supply Mechanism

The device was provided with a roller application device 14 as a device for supplying a condensate (condensate supply mechanism). This allows continuous supply of condensate to the surface of the intermediate transfer body. As the condensate, a liquid obtained by adding a surfactant to a 10% by mass calcium chloride (CaCl₂.2H₂O) aqueous solution.

### Intermediate Image Formation Mechanism

Used as an intermediate image formation mechanism was an inkjet device which ejects ink in an on-demand manner using an electrothermal element.

As the ink, a resin dispersion pigment ink of the following composition shown below was prepared and used (“part” indicates “part by mass”): Pigment color material: C.I. pigment blue 15, 3 parts; Dispersion resin: Styrene-acrylic acid-ethyl acrylate copolymer (Acid value: 240, Weight average molecular weight: 5000), 1 part; Non-water soluble solvent 1: Glycerin, 10 parts; Non-water soluble solvent 2: Ethylene glycol, 5 parts; and Water (ion exchange water), 81 parts.

### Moisture Removal Mechanism

For the purpose of reducing the content of liquid in the ink constituting the image on the intermediate transfer body, the blowing device 16 is disposed as the moisture removal mechanism. As the moisture removal mechanism, the heating heater 17 for heating the intermediate image from the back surface is simultaneously further disposed.

### Transfer Mechanism

The recording device was provided with a pressurization roller 19 which brings the recording medium 18 into contact with the intermediate image formed on the intermediate transfer body to transform and form the image. This device easily achieves efficient image transfer and formation of irregularities by linearly pressurizing the intermediate transfer body, the intermediate image, and the recording medium 18 by the support member 11 and the pressurization roller 19 in such a manner as to quickly sandwich them.

### Cleaning Mechanism

The recording device was further provided with a cleaning unit 20 as the cleaning mechanism in order to repeatedly use the intermediate transfer body after an ink image was supplied to the recording medium, i.e., after the transfer process, for the next image formation. The cleaning unit 20 has a configuration such that a mollton roller which is always humidified with ion exchange water is intermittently made to abut on the surface.

Subsequently, the following operation was performed using this device. First, an intermediate transfer body was selected using the Ra measurement results of the recording medium obtained by the Ra measurement mechanism 10 and the mechanism which selects an intermediate transfer body having an Ra closest to the measurement results from the plurality of intermediate transfer bodies and supplies the same to the intermediate image formation process.

Subsequently, the condensate was supplied to the surface (concavo-convex portion) of the selected intermediate transfer body using the roller application device 14. Thereafter, image formation ink was ejected from the inkjet device 15, and drying was performed using the blowing device 16 and the heating heater 17, so that an intermediate image (mirror reversed image) was formed on the intermediate transfer body. Subsequently, the intermediate image was transferred to the recording medium 18 using the pressurization roller 19. Then, the surface of the intermediate transfer body was cleaned by the cleaning unit 20 for the next image formation.

As the recording medium, four kinds of printing paper (coated paper a to d) shown in Table 2 were used. The Ra of the four kinds of print paper is shown in Table 2. As a conveyance method of each recording medium, each recording medium was conveyed by a conveyor belt. The center line surface roughness (Ra) of the recording medium was measured also using a color 3D laser beam microscope VK-9700 (trade name, manufactured by KEYENCE).

TABLE 2

| | Coated | Coated | Coated | Coated |
|---|---|---|---|---|
| Paper type | paper a | paper b | paper c | paper d |
| Ra [μm] | 0.26 | 1.19 | 2.09 | 2.79 |

The four kinds of coated paper a to d are the following types of printing paper: Coated paper a: Cast coated paper (gloss) manufactured by Oji Paper; Coated paper b: High-quality coated paper (mat) manufactured by Mitsubishi Paper Mills;

Coated paper c: Fine coated paper (gloss) manufactured by Oji Paper; and Coated paper d: Fine coated paper (mat) manufactured by Mitsubishi Paper Mills.

The images formed on each recording medium by the above-described operation were visually evaluated for the image quality (glossy feeling) by sensory evaluation by a plurality of evaluators based on the following criteria. The evaluation results are shown in Table 3.

Image quality evaluation (glossy feeling) criteria: 5: 80 percent or more of the evaluators evaluated that the image quality was favorable; 4: 60 percent or more and lower than 80 percent of the evaluators evaluated that the image quality was favorable; 3: 40 percent or more and lower than 60 percent of the evaluators evaluated that the image quality was favorable; 2: 20 percent or more and lower than 40 percent of the evaluators evaluated that the image quality was favorable; and 1: Lower then 20 percent of the evaluators evaluated that the image quality was favorable.

### Comparative Example 1

An image was formed on each recording medium in the same manner as in Example 1, except using only intermediate transfer bodies 21d-1 in place of the four intermediate transfer bodies (21a-1 to 21d-1), and the image quality was evaluated. The evaluation results are shown in Table 3.

TABLE 3

| Printing target | | Paper type | Coated | Coated | Coated | Coated |
|---|---|---|---|---|---|---|
| | | | paper a | paper b | paper c | paper d |
| | | Ra [μm] | 0.26 | 1.19 | 2.09 | 2.79 |
| Transfer | Example 1 | Intermediate transfer | 21a-1 | 21b-1 | 21c-1 | 21d-1 |
| body | | body | | | | |
| | | Ra [μm] | 0.21 | 1.01 | 1.98 | 2.54 |
| | | Image quality | 5 | 5 | 5 | 4 |
| | | evaluation | | | | |
| | Comparative | Intermediate transfer | 21d-1 | 21d-1 | 21d-1 | 21d-1 |
| | Example 1 | body | | | | |
| | | Ra [μm] | 2.54 | 2.54 | 2.54 | 2.54 |
| | | Image quality | 1 | 2 | 3 | 4 |
| | | evaluation | | | | |

As is clear from Table 3, in Example 1 using, for various kinds of paper different from each other in the center line surface roughness Ra, the intermediate transfer bodies having an Ra closest to the Ra of each of the various kinds of paper, the image quality was equal to or higher than that of Comparative Example 1 using the intermediate transfer bodies in which the Ra were all the same.

### Example 2

In Example 2, the four intermediate transfer bodies (21a-1 to 21d-1) of Example 1 were changed to four intermediate transfer bodies (21a-2 to 21d-2) shown in Table 4. The support member 11 and the surface layer member 12 of the intermediate transfer bodies are the same as those of Example 1. Concavo-convex layers (13a-2-13d-2) of the intermediate transfer bodies (21a-2 to 21d-2) were formed by performing photolitho processing of optical curable urethane-modified acrylic resin (manufactured by TOAGOSEI Co., LTD.) in the same manner as in Example 1. Similarly as in Example 1, an optical cured product of the above-described urethane-modified acrylic resin was separately produced, and the elastic modulus thereof was measured. The elastic modulus at 25° C. of the optical cured product was 330 MPa. An image was formed on each recording medium in the same manner as in Example 1 other then the above, and the image quality was evaluated. The evaluation results are shown in Table 4.

### Comparative Example 2

An image was formed on each recording medium in the same manner as in Example 2, except using only one kind of an intermediate transfer body 21b-2 in place of the four intermediate transfer bodies (21a-2 to 21d-2), and the image quality was evaluated. The evaluation results are shown in Table 4.

TABLE 4

| Printing target | | Paper type | Coated | Coated | Coated | Coated |
|---|---|---|---|---|---|---|
| | | | paper a | paper b | paper c | paper d |
| | | Ra [μm] | 0.26 | 1.19 | 2.09 | 2.79 |
| Transfer | Example 2 | Intermediate transfer | 21a-2 | 21b-2 | 21c-2 | 21d-2 |
| body | | body | | | | |
| | | Ra [μm] | 0.08 | 0.99 | 2.11 | 2.71 |
| | | Image quality | 5 | 5 | 5 | 5 |
| | | evaluation | | | | |
| | Comparative | Intermediate transfer | 21b-2 | 21b-2 | 21b-2 | 21b-2 |
| | Example 2 | body | | | | |
| | | Ra [μm] | 0.99 | 0.99 | 0.99 | 0.99 |
| | | Image quality | 3 | 5 | 2 | 2 |
| | | evaluation | | | | |

Table 4 showed that good image quality was always obtained by using, for various kinds of paper different in the center line surface roughness Ra, the intermediate transfer bodies having an Ra closest to each of the various kinds of paper also in Example 2 using a material whose elastic modulus is lower than that of Example 1.

### Example 3

An image was formed on each recording medium in the same manner as in Example 1, except using two kinds of intermediate transfer bodies (21b-2 and 21d-2) among the four intermediate transfer bodies (21a-2 to 21d-4), and the image quality was evaluated. The evaluation results of Comparative Example 2 above only using the one kind of the intermediate transfer body 21b-2 are also shown as a comparative example in Table 5.

TABLE 5

| Printing target | | Paper type | Coated | Coated | Coated | Coated |
|---|---|---|---|---|---|---|
| | | | paper a | paper b | paper c | paper d |
| | | Ra [μm] | 0.26 | 1.19 | 2.09 | 2.79 |
| Transfer | Example 3 | Intermediate transfer | 21b-2 | 21b-2 | 21d-2 | 21d-2 |
| body | | body | | | | |
| | | Ra [μm] | 0.99 | 0.99 | 2.71 | 2.71 |
| | | Image quality | 3 | 5 | 3 | 5 |
| | | evaluation | | | | |
| | Comparative | Intermediate transfer | 21b-2 | 21b-2 | 21b-2 | 21b-2 |
| | Example 2 | body | | | | |
| | | Ra [μm] | 0.99 | 0.99 | 0.99 | 0.99 |
| | | Image quality | 3 | 5 | 2 | 2 |
| | | evaluation | | | | |

As is seen from Table 5, the same or higher image quality was always obtained to a wide variety of paper types also in Example 3 using two kinds of intermediate transfer bodies different in the center line surface roughness Ra as compared with Comparative Example 2 using only one kind of an intermediate transfer body.

As is clear from the above results, the present invention can provide a transfer type inkjet recording method and a transfer type inkjet recording device which can produce printed substances with few differences in the glossy feeling between the image drawn portion and the non-image-drawn portion and a high commercial value even when various kinds of recording media are used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-251676 filed Nov. 10, 2010, which is hereby incorporated by reference herein in its entirety.

What is claimed is:

1. A transfer type inkjet recording method, comprising:
an intermediate image formation step of forming an intermediate image by supplying ink to the surface of an intermediate transfer body using an inkjet device; and
a transfer step of pressure-bonding a recording medium to the intermediate transfer body on which the intermediate image is formed to transfer the intermediate image to the recording medium, wherein
in the intermediate image formation step, the intermediate transfer body is selected so as to have a center line surface roughness closest to the center line surface roughness of the recording medium in terms of value from a plurality of intermediate transfer bodies different from each other in the center line surface roughness.

2. The transfer inkjet recording method according to claim 1, wherein a difference in the central line surface roughness of the plurality of intermediate transfer bodies is all 0.5 μm or more.

3. A transfer type inkjet recording device, comprising:
an intermediate image formation mechanism for forming an intermediate image by supplying ink to the surface of a selected intermediate transfer body using an inkjet device; and
a transfer mechanism for pressure-bonding a recording medium to the selected intermediate transfer body on which the intermediate image is formed to transfer the intermediate image to the recording medium,
the transfer type inkjet recording device having a plurality of intermediate transfer bodies different from each other in the center line surface roughness, a mechanism for measuring the center line surface roughness of the recording medium, and a mechanism for selecting an intermediate transfer body having a center line surface roughness closest to the measured center line surface roughness of the recording medium in terms of value from the plurality of intermediate transfer bodies and supplying the selected intermediate transfer body to the intermediate image formation mechanism.
